(19) United States
(12) Patent Application Publication
(10) Pub. No.: US 2023/0264543 A1
(43) Pub. Date: Aug. 24, 2023

(54) VEHICLE DOOR WITH A RESONANCE-BODY COMPONENT FOR A SPEAKER, AND MOUNTING METHOD

(71) Applicant: BROSE FAHRZEUGTEILE SE & CO. KOMMANDITGESELLSCHAFT, BAMBERG, Bamberg (DE)

(72) Inventor: Mark WAGNER, Breitengüssbach (DE)

(73) Assignee: BROSE FAHRZEUGTEILE SE & CO. KOMMANDITGESELLSCHAFT, BAMBERG, Bamberg (DE)

(21) Appl. No.: 18/017,798

(22) PCT Filed: Jul. 21, 2021
(86) PCT No.: PCT/EP2021/070332

§ 371 Date: Apr. 21, 2023

(30) Foreign Application Priority Data
Jul. 24, 2020 (DE) 10 2020 209 380.6

(51) Int. Cl. B60J 5/04; E05F 15/689; B60J 1/17; H04R 1/02; H04R 1/28

(52) U.S. Cl. CPC B60J 5/0413; B60J 1/17; B60J 5/0418; E05F 15/689; H04R 1/025; H04R 1/2811; E05Y 2201/434; E05Y 2201/684; E05Y 2600/46; E05Y 2600/626; E05Y 2900/531; E05Y 2900/55; H04R 2499/13

(57) ABSTRACT

A vehicle door that includes at least a door skin, a carrier component fixed the door skin for separating a wet space from a dry space on the vehicle door, wherein the carrier component has a wet-space side facing the wet space and a dry-space side facing the dry space, a speaker arranged on the carrier component, and a resonance body component connected the carrier component for forming a resonance space for the speaker on the wet-space side of the carrier component. The resonance body component, which together with the carrier component forms the resonance space for the speaker, forms a rail carrier surface on which at least one guide rail is provided for a window regulator of the vehicle door.

### CROSS-REFERENCE TO RELATED APPLICATIONS

This application is the U.S. National Phase of PCT/EP2021/070332 filed Jul. 21, 2021, which claims priority to German Application No. DE 10 2020 209 380.6 filed Jul. 24, 2020, the entire disclosures of which are incorporated by reference herein.

### TECHNICAL FIELD

The proposed solution relates in particular to a vehicle door with a resonance body component for forming a resonance space within a vehicle door for a speaker.

### BACKGROUND

A vehicle door may include a resonance body for a speaker of the vehicle door within a vehicle door on a carrier component provided on the vehicle door for separating a wet space from a dry space. This resonance body may be formed by at least one resonance body component that defines a resonance space for the speaker. A corresponding resonance body component, which usually is also referred to as “soundbox”, usually is fixed to a dry-space side of the carrier component as an additional component and thereon forms a resonance space of defined size, but of comparatively small volume. The volume of the resonance space typically is merely a fraction of the volume of the dry space. For example, the volume of the resonance space may be ⅒ of a volume of the dry space.

From DE 197 17 908 B4 it is furthermore known to form a resonance space by a profile molded to the carrier component itself. The resonance space here is to be provided on a dry-space side of the carrier component. This leads to a comparatively large demand of installation space and also possibly disadvantageously impairs the design of an interior door trim on the dry-space side.

Against this background it therefore is the object underlying the proposed solution to provide an improved vehicle door with a resonance space for a speaker.

### SUMMARY

A proposed vehicle door includes at least one resonance body component, which together with the carrier component forms a resonance space for a speaker of the vehicle door and which is provided on a wet-space side of the carrier component facing a wet space of the vehicle door. Via the at least one resonance body component (i.e. a single resonance body component or a plurality of resonance body components) an installation space provided within the wet space is used in this way for the resonance space. Furthermore, it is provided that the resonance body component forms a rail carrier surface on which at least one guide rail is provided for a window regulator of the vehicle door.

Due to the fact that the resonance body component may integrate an additional function by forming a rail carrier surface for at least one guide rail of the vehicle door, the resonance body component can be designed distinctly larger, which in turn leads to a distinctly larger volume for the resonance space of the speaker. The larger dimensions of the resonance body component as compared to the previously usual constructions also can lead to an improved thermal and/or acoustic insulation via the resonance body component within the vehicle door.

As such, the resonance body component can carry at least one guide rail for the window regulator of the vehicle door on its additionally provided rail carrier surface. This in particular includes the fact that the guide rail at least partly may be integrally formed on the rail carrier surface of the resonance body component or fixed thereto. In principle, the at least one guide rail also can additionally be fixed to the carrier component or to a door skin of the vehicle door away from the resonance body component. One design variant nevertheless provides that the at least one guide rail exclusively is integrally formed on the resonance body component or fixed thereto, and this resonance body component is connected to the carrier component provided for the wet/dry space separation. Thus, in a design variant based thereon, a functional separation is provided. The carrier component, which possibly also still carries functional components of the vehicle door (in addition to the at least one guide rail), is adapted and provided for the wet/dry space separation, while the resonance body component in conjunction with the carrier component on the one hand is adapted and provided for forming a resonance space for the door-side speaker and on the other hand for positioning the at least one guide rail of the window regulator within the wet space.

In one design variant, the rail carrier surface of the resonance body component for the at least one guide rail faces the wet space and at least one body portion of the resonance body component forming the rail carrier surface is located opposite a carrier portion of the wet-space side of the carrier component. In this way, a clearance belonging to the resonance space is formed between the body portion and the carrier portion.

This in particular includes the possibility to form the resonance body component as a comparatively large-surface component, which covers an essential part of the wet-space side of the carrier component in order to define a resonance space. The resonance space thus can occupy a substantial volume within the wet space. Covering an essential part of the wet-space side of the carrier component here means that the resonance body component covers more than 30%, in particular more than 40%, more than 50% or more than 60% of the wet-space side of the carrier component bordering the wet space.

As already explained above, in particular in such a design variant the resonance body component can carry the at least one guide rail of the window regulator and can be attached to the carrier component. In addition, an attachment of the resonance body component to the door skin of the vehicle door carrying the door component, for example to a door inner skin, can be provided. A corresponding attachment in particular is independent of whether the at least one guide rail is configured as a separate component and fixed to the resonance body component on the rail carrier surface or whether the at least one guide rail is configured as an integral part of the resonance body component and hence integrally molded thereto.

To integrate a further function into the resonance body component in one design variant, the resonance body component additionally can form a drive carrier surface to which a drive of a window regulator of the vehicle door is mounted. The drive mounted to the drive carrier surface of the resonance body component then for example can include a drive motor and a transmission coupled thereto for the adjustment of a window pane of the vehicle door. Instead of providing such a drive on the carrier component provided for the wet/dry space separation, for example a door module carrier of flat design, the resonance body component provided for forming the resonance space for the speaker in this design variant consequently is also used to carry the drive of the window regulator.

In a development based thereon, the drive carrier surface also can face the resonance space and be located opposite the carrier portion of the wet-space side of the carrier component. In this way, the drive of the window regulator consequently can at least partly be arranged in the space formed between the body portion of the resonance body component and a carrier portion of the carrier component and hence in the resonance space. Between a body portion of the resonance body component forming the rail carrier surface and possibly in addition the drive carrier surface and the wet-space side of the carrier component a cavity or clearance thus is defined for the resonance space, in which the drive of the window regulator is received.

Alternatively or in addition, the resonance body component additionally can form a lock carrier surface to which a door lock of the vehicle door is mounted. In this variant, the resonance body component consequently forms an additional lock carrier surface that carries at least part of a door lock of the vehicle door. Such a lock carrier surface then for example can laterally protrude from the rail carrier surface of the resonance body component.

As explained already, the resonance body component in principle can (also) be directly fixed to a door skin of the vehicle door. To facilitate in particular a pre-assembly of the resonance body component on the carrier component and to be able to already fix the resonance body component to the carrier component in a proper end position, before the carrier component is mounted to the door skin and hence to a door bodyshell formed therewith, the resonance body component in one design variant can be fixed exclusively to the carrier component. This in particular includes a variant in which the resonance body component comprises an edge defining the outer contour of the resonance body component, which is circumferentially (on the wet-space side) connected to the carrier component.

The proposed solution furthermore provides a mounting method for mounting a door assembly for a vehicle door, which comprises at least the following steps:
providing a door skin for the vehicle door (in particular as part of a door bodyshell to which further components are to be mounted),
providing a carrier component to be fixed to the door skin for separating a wet space from a dry space on the vehicle door, wherein the carrier component has a wet-space side facing the wet space and a dry-space side facing the dry space, and a speaker is arranged on the carrier component,
providing a resonance body component to be connected to the carrier component for forming a resonance space for the speaker on the wet-space side of the carrier component, and
providing at least one guide rail for a window regulator of the vehicle door on the resonance body component, wherein the at least one guide rail then is fixed to the carrier component via the connection of the resonance body component to the carrier component.

In the proposed mounting method, the at least one guide rail at the end of assembly consequently is fixed to the carrier component via the resonance body component. This in particular includes the fact that the at least one guide rail initially is fixed to the resonance body component as a separate component, before the resonance body component with the guide rail already fixed thereto is mounted to the wet-space side of the carrier component. Furthermore, however, a proposed mounting method also includes a design variant in which the resonance body component initially is mounted to the wet-space side of the carrier component, before subsequently the at least one guide rail is fixed to the resonance body component. Alternatively, the at least one guide rail can also be integrally molded to the resonance body component.

In principle, the resonance space for the speaker can be formed only upon connection of the resonance body component to the carrier component. Via the attachment of the resonance body component to the carrier component, the resonance space consequently is defined as a cavity between a body portion of the resonance body component and the wet-space side of the carrier component.

Via a design variant of a proposed mounting method, in particular one design variant of a proposed vehicle door can be mounted. The advantages and features of design variants of a proposed vehicle door as explained above and below thus also apply for design variants of a proposed mounting method, and vice versa.

Another aspect of the proposed solution furthermore relates to a vehicle door comprising at least
a door skin,
a carrier component fixed to the door skin for separating a wet space from a dry space on the vehicle door, wherein the carrier component includes a wet-space side facing the wet space and a dry-space side facing the dry space,
a speaker arranged on a speaker mounting surface of the carrier component,
a guide rail provided on a carrier surface of the carrier component for a window regulator of the vehicle door, and
a resonance body component connected to the carrier component for forming a resonance space for the speaker on the wet-space side of the carrier component.

A carrier portion of the carrier component forming the speaker mounting surface is set back with respect to the carrier surface on the wet-space side of the carrier component, wherein on the wet-space side of the carrier portion the resonance body component is attached to this carrier portion set back on the wet-space side.

In the vehicle door proposed here, the carrier portion of the carrier component for the speaker mounting surface consequently is set back with respect to a carrier surface on which the at least one guide rail is fixed or integrally formed, in order to provide a larger volume within the wet space for the resonance space for the speaker, which is formed with the attachment of the resonance body component to the wet-space side of the carrier component.

The resonance body component can protrude relative to an opposite carrier portion in the direction of a door outer skin bordering the wet space up to a reference plane or beyond, in which the carrier surface of the carrier component extends. Thus, the resonance body component maximally bridges a setback with respect to the reference plane on the (flat) carrier component, which is provided for the speaker mounting surface. Within the wet space, the carrier component with the resonance body component fixed thereto thus for example does not protrude any further in the direction of a door outer skin than the carrier surface of the carrier component, on which the at least one guide rail for the window regulator is provided, i.e. for example is fixed or integrally formed thereon. Correspondingly, an adjustable window pane of the vehicle door for example still can easily be guided past the resonance body component within the wet space.

### BRIEF DESCRIPTION OF THE DRAWINGS

The attached Figures by way of example illustrate possible design variants of the proposed solution.

In the drawings:

FIG. 1 sectionally shows a vehicle door with a view to a wet-space side of a door module carrier of the vehicle door;

FIG. 1A shows a sectional view of the vehicle door along the sectional line A-A of FIG. 1;

FIG. 2 shows a modified variant of the vehicle door of FIG. 1 in a view corresponding with FIG. 1;

FIG. 2A shows a sectional view of the vehicle door along the sectional line A-A of FIG. 2;

FIG. 3 in views corresponding with FIGS. 1 and 2 shows a vehicle door without a resonance body component for a speaker of the vehicle door.

### DETAILED DESCRIPTION

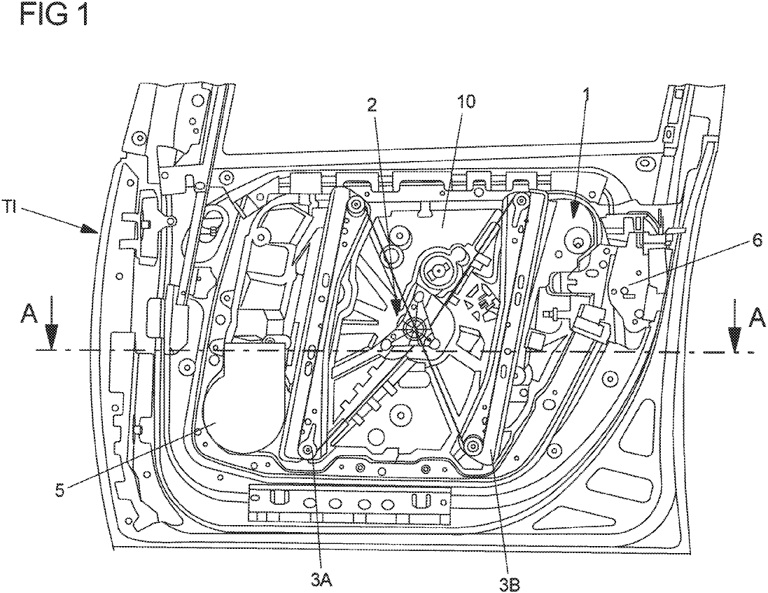

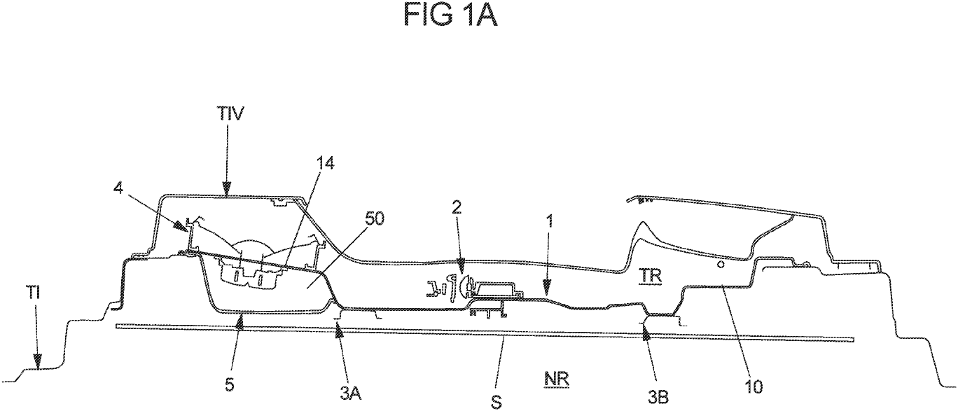

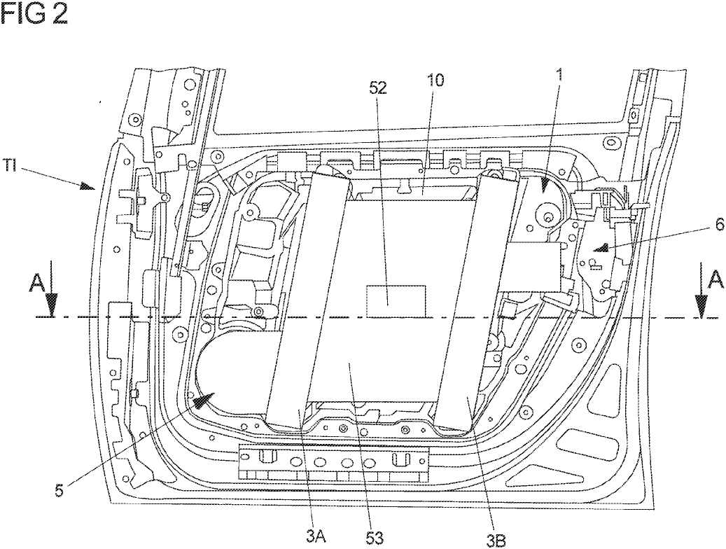

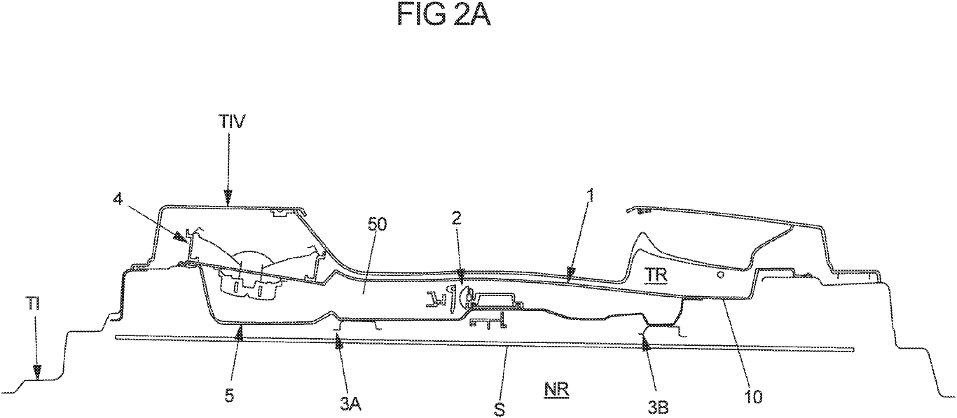

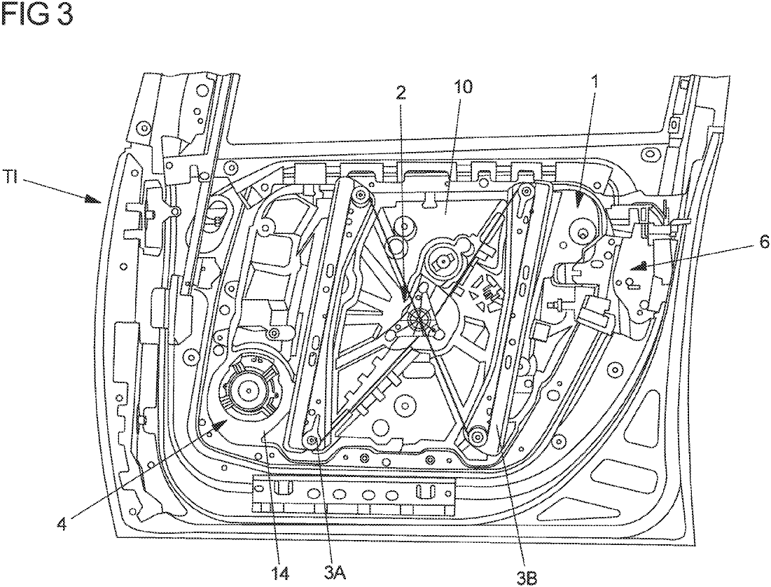

FIG. 1 shows a vehicle door with a view to a wet-space side of a carrier component in the form of a door module carrier 1. The vehicle door comprises a door inner skin TI, for example in the form of a door inner panel. In a manner known per se, the door inner skin TI together with a door outer skin not shown in FIG. 3 defines a wet space NR (cf. FIGS. 1A and 2A), in which parts of a window regulator are arranged in order to be able to lift and lower a window pane of the vehicle door. The window pane in particular can be lowered into this wet space NR.

For separating the wet space NR from a dry space TR facing the vehicle interior the door module carrier 1 is provided. The door module carrier 1 closes an opening provided at the door inner skin TI, via which in particular the functional components of the window regulator can be positioned in the wet space NR. On a wet-space side facing the wet space NR the door module carrier 1 therefor has a carrier surface 10 on which functional components of the window regulator are provided. These include in particular two longitudinally extending guide rails 3A and 3B, which in the case of the vehicle door 1 of FIG. 3 are fixed to the carrier surface 10 as separate components. The guide rails 3A and 3B serve to define a guideway for the window pane to be adjusted. Furthermore, a window regulator drive 2 is fixed to the door module carrier 1. Moisture-sensitive components of the window regulator drive 2 are located on a dry-space side of the door module carrier 1 facing away from the wet space NR. A cable drum of the window regulator drive 2 for driving a Bowden cable for the adjustment of the window pane in turn is provided on the carrier surface 10 on the wet-space side. The door module carrier 1 furthermore carries a door lock 6 and a speaker 4 as further functional components.

To utilize a volume provided within the wet space NR for a defined resonance space for the speaker 4, a design variant of FIGS. 1 and 1A provides for the vehicle door of FIG. 3 to provide a resonance body component 5 on the wet-space side of the door module carrier 1. This resonance body component 5 forms a so-called “soundbox”, which on the wet-space side of the door module carrier 1 surrounds the speaker 4 received in a speaker opening of the door module carrier 1 like a housing. In this way, the resonance body component 5 defines a closed resonance space 50 of defined size within the wet space NR for the speaker 4. With a body portion protruding in the direction of the door outer skin and an opposite carrier portion of the door module carrier 1, the resonance body component 5 of FIGS. 1 and 1A defines a cavity or clearance as a resonance space 50 into which the speaker 4 protrudes.

In FIGS. 1 and 1A the carrier portion of the door module carrier 1 located opposite the protruding body portion of the resonance body component 5 forms a speaker mounting surface 14 with the speaker opening for the speaker 4, which is set back in the direction of the door interior space with respect to the carrier surface 10 of the door module carrier 1 carrying the guide rails 3A and 3B. In this way, the resonance body component 5 utilizes a setback present on the door module carrier 1 with respect to the carrier surface 10 in order to define the closed resonance space 50, without protruding from the carrier surface 10 and in particular the guide rails 3A and 3B provided thereon in the direction of the door outer skin. The resonance body for the speaker 4 formed with the resonance body component 5 in the direction of the door outer skin thus does not impair the adjustability of a window pane S guided along the guide rails 3A, 3B within the wet space NR.

In a development according to FIGS. 2 and 2A, the resonance body component 5 constitutes a large-surface component which in the mounted state covers a large part of the wet-space side of the door module carrier 1. For example, there is provided a coverage of more than 50% by the resonance body component 5. In this way, the resonance body component 5 of FIGS. 2 and 2A in conjunction with the opposite carrier portions of the door module carrier 1 forms a resonance space 50 of comparatively large volume. For example, the volume of the resonance space 50 can be more than 20%, in particular more than 30% or more than 35% of the total volume of the wet space NR. Nevertheless, the resonance body component 5 of FIGS. 2 and 2A is circumferentially connected to the door module carrier 1 at its edge defining the outer contour of the resonance body component 5.

To create the resonance space 50 of such a comparatively large volume, additional functions are integrated into the resonance body component 5 of FIGS. 2 and 2A. On a body portion protruding in the direction of the door outer skin with respect to the carrier surface 10 of the door module carrier 1, the resonance body component 5 has a large-surface rail carrier surface 53 on which the guide rails 3A, 3B for the window regulator of the vehicle door are provided. The guide rails 3A, 3B here can be fixed to the rail carrier surface 53 as separate components. Alternatively, at least one of the guide rails 3A, 3B on the rail carrier surface 53 can be formed as an integral part of the resonance body component 5 and hence can be formed by the resonance body component 5.

In the design variant of FIGS. 2 and 2A, the resonance body component 5 furthermore forms a lock carrier surface 56 laterally protruding from the rail carrier surface 53, to which the door lock 6 is fixed.

In addition, a drive carrier surface 52 is formed by the resonance body component 5. The window regulator drive 2 for the window regulator is fixed to this drive carrier surface 52 so that the components of the window regulator drive 2 to be protected from moisture are arranged within the resonance space 50 formed between the carrier component 1 and the resonance body component 5.

In the design variant of FIGS. 2 and 2A, the door module carrier 1 chiefly performs the wet/dry space separation, while via the resonance body component 5 a plurality of functional components are properly positioned and held within the vehicle door and with respect to the door module carrier 1.

For mounting the vehicle door of FIGS. 2 and 2A it can be provided for example that initially the resonance body component 5 is mounted to the carrier surface 10 of the door module carrier 1, possibly before or after functional components, such as the guide rails 3A, 3B and the door lock 6, have been mounted to the resonance body component, and before or after the speaker 4 has been arranged in the speaker opening of the door module carrier 1. Subsequently, the door module carrier 1 with the resonance body component 5 held at the carrier surface 10 is positioned within the wet space NR via the opening in the door inner skin TI, and the door module carrier 1 is fixed to the door inner skin TI. As a result, the closed resonance space 50 defined with the resonance body component 5 then is present within the wet space NR, and the wet space NR is separated from the dry space TR via the door module carrier 1 sealingly resting against the door inner skin TI.

In particular in the design variant of FIGS. 2 and 2A with a comparatively large-surface resonance body component 5, on which in particular the guide rails 3A and 3B of the window regulator are provided, it is not only easily possible to provide a comparatively large resonance space 50 for the speaker 4 within the vehicle door. Rather, an effective thermal and/or acoustic insulation within the vehicle door is also realized via the resonance body component 5.

List of reference numerals

| | |
|---|---|
| 1 | door module carrier (carrier component) |
| 10 | carrier surface |
| 14 | speaker mounting surface |
| 2 | window regulator drive |
| 3A, 3B | guide rail |
| 4 | speaker |
| 5 | resonance body component |
| 50 | resonance space |
| 52 | drive carrier surface |
| 53 | rail carrier surface |
| 56 | lock carrier surface |
| 6 | door lock |
| NR | wet space |
| S | window pane |
| TI | door inner skin |
| TIV | interior door trim |
| TR | dry space |

1. A vehicle door, comprising at least
a door skin;
a carrier component fixed to the door skin and configured to separate a wet space from a dry space on the vehicle door, wherein the carrier component has a wet-space side facing the wet space and a dry-space side facing the dry space,
a speaker arranged on the carrier component, and
a resonance body component connected to the carrier component for forming a resonance space for the speaker on the wet-space side of the carrier component, wherein
the resonance body component, in conjunction with the carrier component forms the resonance space for the speaker, and wherein the resonance body component further forms
a rail carrier surface on which at least one guide rail is provided for a window regulator of the vehicle door.

2. The vehicle door of claim 1, wherein the rail carrier surface of the resonance body component for the at least one guide rail faces the wet space and at least one body portion of the resonance body component forming the rail carrier surface is located opposite a carrier portion of the wet-space side of the carrier component so that between the body portion and the carrier portion a clearance belonging to the resonance space is formed.

3. The vehicle door of claim 2, wherein the resonance body component carries the at least one guide rail and is attached to the carrier component.

4. The vehicle door of claim 3, wherein the at least one guide rail is formed as a separate component which is fixed to the resonance body component.

5. The vehicle door of claim 3, wherein the at least one guide rail is formed as an integral part of the resonance body component.

6. The vehicle door of claim 5, wherein the resonance body component additionally forms a drive carrier surface to which a drive of a window regulator of the vehicle door is mounted.

7. The vehicle door of claim 6, wherein the drive carrier surface faces the resonance space and is located opposite the carrier portion of the wet-space side of the carrier component.

8. The vehicle door of claim 7, wherein the resonance body component additionally forms a lock carrier surface to which a door lock of the vehicle door is mounted.

9. The vehicle door of claim 8, wherein the resonance body component is configured as a flat component connected to the carrier component.

10. The vehicle door of claim 9, wherein the resonance body component comprises an edge defining the outer contour of the resonance body component, which is circumferentially connected to the carrier component.

11. A method for mounting a door assembly for a vehicle door, comprising at least the following steps:
providing a door skin for the vehicle door;
providing a carrier component to be fixed to the door skin for separating a wet space from a dry space on the vehicle door, wherein the carrier component has a wet-space side facing the wet space and a dry-space side facing the dry space, and a speaker arranged on the carrier component, and
providing a resonance body component to be connected to the carrier component for forming a resonance space for the speaker on the wet-space side of the carrier component, wherein
on the resonance body component at least one guide rail is provided, which is fixed to the carrier component via a connection of the resonance body component to the carrier component.

12. The method according to claim 11, wherein with the connection of the resonance body component to the carrier component the resonance space for the speaker is formed.

13. A vehicle door, comprising at least
a door skin,
a carrier component fixed the door skin for separating a wet space from a dry space on the vehicle door, wherein the carrier component includes a wet-space side facing the wet space and a dry-space side facing the dry space,
a speaker arranged on a speaker mounting surface of the carrier component,
a guide rail provided on a carrier surface of the carrier component, wherein the guide rail holds a window regulator of the vehicle door, and
a resonance body component connected to the carrier component for forming a resonance space for the speaker on the wet-space side of the carrier component, wherein the carrier comoponent includes
a carrier portion forming the speaker mounting surface is set back with respect to the carrier surface on the wet-space side of the carrier component, and the resonance body component is attached to this carrier portion on the wet-space side.
